(19) United States
(12) Patent Application Publication
(10) Pub. No.: US 2025/0228256 A1
(43) Pub. Date: Jul. 17, 2025

(54) INGREDIENT FOR FOOD PRESERVATION

(71) Applicant: MILLBO S.R.L., Trecate (NO) (IT)

(72) Inventors: Bruno Boggiani, Paradiso (CH); Sara Scardino, Trecate (NO) (IT)

(73) Assignee: MILLBO S.R.L., Trecate (NO) (IT)

(21) Appl. No.: 18/698,252

(22) PCT Filed: Oct. 3, 2022
(86) PCT No.: PCT/IB2022/059425

§ 371 Date: Apr. 3, 2024

(30) Foreign Application Priority Data
Oct. 4, 2021 (IT) 102021000025409
Nov. 18, 2021 (WO) PCT/IB2021/060708

(51) Int. Cl. A21D 2/14; A21D 8/04; A23B 2/733; A23B 2/754

(52) U.S. Cl. CPC A21D 2/145; A21D 8/04; A23B 2/733; A23B 2/754

(57) ABSTRACT

The present invention fits into the field of preservation of foods, preferably baked products, and relates to a composition comprising fermented flour obtained from fermentation by means of lactic and/or propionic acid bacteria, an extract of plant origin, more specifically an extract of Sorbus aucuparia L., and a carrier. The present invention also relates to the use of said composition, preferably in powder form, as an additive for the preservation of foods, preferably baked products. Preferably, the composition of the invention is added to the ingredients for preparing the above-mentioned foods prior to baking.

### FIELD OF THE INVENTION

The present invention fits into the field of preservation of foods, preferably baked products, and relates to a composition comprising fermented flour, an extract of plant origin and a carrier. The present invention also relates to the use of the composition as an additive for the preservation of said foods.

### PRIOR ART

Food preservation technologies have the principal aim of preserving the physical and nutritional properties of foods over time and preventing and/or limiting the proliferation of bacteria, fungi, moulds or other microorganisms over time, as well as delaying lipid oxidation, which is responsible for the phenomenon of rancidity.

It thus appears clear that the development of such technologies is of fundamental importance not only from a food safety perspective, but also in terms of environmental sustainability, since a greater and more effective preservation of foods can help to combat food waste.

Many foods, including baked products, such as, for example bread or biscuits, are characterised by a high water activity value (a_{w}), which represents, in fact, the water available for microbial proliferation. This means that these products, despite being baked at high temperatures, actually have a limited shelf life once they have come out of the oven, since they are highly susceptible to contamination by mould and bacteria naturally present in the surrounding air. In other words, any baked product, if exposed to the surrounding environment and stored at room temperature, will undergo visible deterioration after between 2 and 7 days.

It thus appears clear why, in this sector, increasing efforts have been focused on finding solutions that can enable the storage time (or shelf life) of such baked products to be increased. One of the most widely adopted solutions is to supplement the doughs or batters with additives with a preservative action that can delay and/or reduce deterioration by moulds and/or bacteria.

Propionic acid is among the most commonly used food additives; it is a good preservative of baked products, though its effectiveness does not extend beyond 7-8 days of storage. Furthermore, an additional limitation derives from the fact that, because of its characteristic odour and flavour, this additive must be used in small quantities.

Another preservative usually employed in the sector is sorbic acid, which, though it has a neutral odour and flavour and hence does not pose any major problems of use, has a limitation tied to the inhibition/destruction of the action of yeast, and thus proves to be particularly disadvantageous for many applications, especially in the breadmaking industry.

The present invention solves the problems of the prior art by providing a composition of natural origin which, when used as an additive within food formulations, and particularly those of baked products, enables the shelf life of such foods to be extended by avoiding the proliferation of moulds and bacteria and the consequent deterioration thereof.

### SUMMARY OF THE INVENTION

The present invention relates to a composition comprising fermented flour obtained from fermentation with lactic and/or propionic acid bacteria, an extract of Sorbus aucuparia L., and a carrier.

For the purposes of the present invention, the composition is also definable as a “natural composition” or “composition of natural origin”, indicating that the composition comprises solely “natural” products, i.e. products of natural origin.

According to the present invention, the fermented flour comprises at least one organic acid selected in the group consisting of: propionic acid, lactic acid, succinic acid, citric acid, and a combination thereof, whilst said extract comprises sorbic acid.

Preferably, the fermented flour is obtained by subjecting to fermentation a flour selected in the group consisting of: white flour, semi-wholemeal flour, wholemeal flour or combination thereof, more a preferably white wheat flour, semi-whole wheat flour, whole wheat flour, white rice flour, semi-wholegrain rice flour, wholegrain rice flour, or a combination thereof.

According to one embodiment, the composition according to the present invention comprises the fermented flour and the extract in a ratio by weight comprised between 20:80 and 80:20.

Preferably, the composition according to the present invention comprises sorbic acid deriving from the extract in a total amount comprised between 20 and 40% by weight relative to the total weight of the composition.

According to one embodiment, the composition of the invention is in powder form.

The present invention also relates to the use of the composition as described above as an additive for the preservation of foods, preferably baked products selected in the group consisting of: bread, biscuits, filled baked products, croissants, leavened breakfast products, cakes, and a combination thereof.

According to one embodiment, said foods are selected in the group consisting of jam and/or cream, preferably jam and/or cream for pastries and/or breads.

Preferably, the composition of the invention is added to the ingredients for preparing the above-mentioned foods prior to baking.

### BRIEF DESCRIPTION OF THE FIGURES

FIG. 1 shows a graph illustrating the appearance and quantification of mould over time according to the different samples of sandwich bread as described in Example 1. Legend: standard (std); fermented flour 1000 ppm relative to the weight of the flour (A); fermented flour 1500 ppm relative to the weight of the flour (B); fermented flour 2000 ppm relative to the weight of the flour (C); extract 500 ppm relative to the total of the recipe (D); extract 1000 ppm relative to the total of the recipe (E); extract 1500 ppm relative to the total of the recipe (F); fermented flour and extract mixture (G).

FIG. 2 shows a graph illustrating the appearance and quantification of mould over time according to the different samples of pandolce (“sweet bread”) as described in Example 2. Legend: standard (std); fermented flour 1000 ppm relative to the weight of the flour (A); fermented flour 1500 ppm relative to the weight of the flour (B); fermented flour 2000 ppm relative to the weight of the flour (C); extract 500 ppm relative to the total of the recipe (D); extract 1000 ppm relative to the total of the recipe (E); extract 1500 ppm relative to the total of the recipe (F); fermented flour and extract mixture (G).

FIG. 3 shows a graph illustrating the appearance of mould over time according to the recipe used. Legend: Standard sandwich bread; A: flour fermented by lactic bacteria and a botanical extract in combination; B: flour fermented by propionic acid bacteria and botanical extract in combination.

### DETAILED DESCRIPTION OF THE INVENTION

For the purposes of the present invention, the expression “shelf life” indicates the period of time that corresponds, under given storage conditions, to a tolerable decrease in the quality of a food. The concept of shelf life is thus correlated to the concept of food quality, but cannot fail to take account of the microbiological aspect, which, together with the physicochemical and enzymatic characteristics, contributes to defining the fitness for consumption of the food itself.

The present invention relates to a composition comprising:
a) fermented flour obtained from the fermentation of at least one flour with lactic and/or propionic acid bacteria, said fermented flour comprising at least one organic acid selected in the group consisting of: propionic acid, lactic acid, succinic acid, citric acid and a combination thereof;
b) an extract of Sorbus aucuparia L., said extract comprising sorbic acid;
c) a carrier selected in the group consisting of: tapioca, maize starch, rice maltodextrins, maize maltodextrins, and a combination thereof.

Preferably, the fermented flour a) is obtained by subjecting at least one flour selected in the group consisting of: white flour, semi-wholemeal flour, wholemeal flour or combination thereof, more a preferably white wheat flour, semi-whole wheat flour, whole wheat flour, white rice flour, semi-wholegrain rice flour, wholegrain rice flour, or a combination thereof to fermentation with said lactic and/or propionic acid bacteria.

For the purposes of the present invention, said extract of Sorbus aucuparia L. is also definable as a “botanical extract” or an “extract of plant origin”.

Preferably, said extract of Sorbus aucuparia L. b) is an extract obtained by subjecting berries of Sorbus aucuparia L. to an extraction process, preferably to an extraction process with an alcohol and/or water, preferably with ethanol and/or water, more preferably with water.

For the purposes of the present invention the “berry of Sorbus aucuparia L” is also defined as “rowan berry”.

According to a particularly preferred embodiment of the present invention, the extraction process is carried out at room temperature.

According to one embodiment of the composition according to the present invention, the fermented flour a) and the extract of Sorbus aucuparia L. b) as described above are present within the composition in a ratio by weight a):b) comprised between 20:80 and 80:20, preferably in a ratio by weight comprised between 30:70 and 70:30, more preferably in a ratio by weight equal to about 50:50.

According to one embodiment, the composition according to the present invention comprises sorbic acid deriving from the extract in a total amount comprised between 20 and 40% by weight, preferably between 25 and 35% by weight, more preferably equal to about 30% by weight relative to the total weight of the composition.

According to one embodiment, the composition according to the present invention consists essentially of the above-described ingredients a)-c).

According to another embodiment, the composition according to the present invention consists of the above-described ingredients a)-c).

Preferably, the composition of the present invention according to any one of the above-described embodiments is formulated in powder form.

Advantageously, the formulation in powder form ensures that the composition according to the present invention can be easily and effectively added in normal food preparation processes. For example, in the case of baked products, the powder composition according to a preferred embodiment of the present invention can be added directly to the dough or batter of the products (for example by mixing it with the flour).

The present invention also relates to the use of the composition according to any one of the above-described embodiments as an additive for food preservation. The composition according to the present invention in fact makes it possible to enhance the preservation (and in fact prolong the shelf life) of foods to which the composition is added.

Preferably, the composition is added to the ingredients used to prepare the foods prior to baking. Said ingredients preferably comprise at least flour and/or water.

According to a particularly preferred embodiment, said foods are baked products. Preferably, the baked products are selected in the group consisting of; bread, biscuits, filled baked products, croissants, leavened breakfast products, cakes, and a combination thereof.

According to one embodiment, said foods are selected in the group consisting of jam and/or cream, preferably jam and/or cream for pastries and/or breads.

Without wishing to be bound to a specific theory, the Applicant has nonetheless found that the composition according to the present invention, by virtue of the specific combination of ingredients (in particular thanks to the combination of fermented flour and the extract of Sorbus aucuparia L. according to any one of the above-described embodiments), exhibits an effectiveness characterised by a synergistic effect between the fermented flour and the extract, without, at the same time, significantly influencing the process of preparation and/or the final organoleptic characteristics of the foods, such as, for example, the colour, outer appearance and/or flavour.

### EXAMPLES

### Example 1—Comparative Shelf Life Test on Sandwich Bread

Comparative tests were performed in order to evaluate the synergistic effect given by the combination of the fermented flour a) and the extract of Sorbus aucuparia L. b) within the composition according to the present invention.

The tests were performed by comparing the preservation proprieties of “standard” sandwich bread, i.e. made without the addition of additives, with sandwich bread made following the same basic recipe but adding:
a) Fermented flour
b) Extract of Sorbus aucuparia L.
a)+b) Mixture of fermented flour and extract of Sorbus aucuparia L.

The performance of the tests involved a first baking step and a second step of studying the shelf life, i.e. of evaluating the appearance of mould visible on different samples and quantitative analysis.

The basic recipe followed for the preparation of the different samples provides for the use of flour of breadmaking quality, water in an amount comprised between 40 and 80% relative to the weight of the flour, yeast, salt and micro ingredients.

The different samples of sandwich bread prepared are the following:
Standard
A: Standard+fermented flour a) 1000 ppm relative to the weight of the flour
B: Standard+fermented flour a) 1500 ppm relative to the weight of the flour
C: Standard+fermented flour a) 2000 ppm relative to the weight of the flour
D: Standard+Extract of Sorbus aucuparia L. b) 500 ppm relative to the total of the recipe
E: Standard+Extract of Sorbus aucuparia L. b) 1000 ppm relative to the total of the recipe
F: Standard+Extract of Sorbus aucuparia L. b) 1500 ppm relative to the total of the recipe
G: Standard+fermented flour a)+Extract of Sorbus aucuparia L. b).

All of the doughs were prepared on the same day so as to be able to work under the same operating conditions and thus avoid influencing the tests in any way. For the preparation of the dough, the first step was to weigh the ingredients foreseen for each sample and place them in a spiral kneader. The kneading step provided for 3 minutes at a first speed followed by 10 minutes at a second speed. Once the kneading step had ended, the dough was left to rest at room temperature for 10 minutes. Following this rest phase, the dough was split and shaped. The dough was divided and placed in closed loaf pans so as to have portions weighing 550 g each. The leavening step provided for rest in a chamber for 60 minutes at a temperature of 30° C. with a relative humidity of 80%. The doughs thus leavened were baked in an oven at a temperature of 240° C. for a time of 45 minutes. Once the loaves had cooled completely, they were cut so as to have slices of uniform thickness. Every slice was individually packaged and sealed. An evaluation was then made of the mould visible during the shelf life of the products. All of the bread slices of all samples were stored under the same conditions in order to avoid influencing the test in any way.

As may be appreciated from the graph shown in FIG. 1, the sandwich bread made with the composition according to the present invention comprising a combination of fermented flour a) and extract of Sorbus aucuparia L. b) (sample G=combination a)+b)) showed a delayed appearance of mould: on the fourth day, compared to the first or second day as was instead the case for all the other samples, and in particular in the case of samples comprising solely fermented flour a) or solely extract of Sorbus aucuparia L. b). Furthermore, the amount of mould that formed was ≤40% for the entire duration of the test (19 days), whereas in the case of the other samples the amount of mould present was already between 80% and 100% after the fourth day. These results demonstrate the synergistic effect of the composition according to the present invention in improving and prolonging the shelf life of sandwich bread and in particular the synergistic effect given by the use of the combination of fermented flour a) and the extract of Sorbus aucuparia L. b) compared to the use of these two ingredients added individually.

### Example 2—Comparative Shelf Life Tests on a Sweet Baked Product with a High Sugar and Fat Content

In order to have further evidence in support of the synergistic effect of the composition according to the present invention, tests were also performed on a sweet baked product with a high sugar and fat content, defined as “pandolce”.

As in the case of the sandwich bread of Example 1, in this case as well the tests were performed by comparing the preservation properties of a “standard” pandolce, i.e. made without the addition of additives, with a pandolce made following the same basic recipe but adding:
a) Fermented flour
b) Extract of Sorbus aucuparia L.
a)+b) Mixture of fermented flour and an extract of Sorbus aucuparia L.

As in Example 1, in this case as well the performance of the tests included a first baking step and a second step of studying the shelf life, i.e. of evaluating visible mould in relation to the different recipes.

The basic recipe followed to prepare the different samples provides for the use of flour, a fat-based product, sugar, eggs, milk, a chemical leavener and micronutrients.

The different samples of pandolce prepared are the following:
Standard
A: Standard+fermented flour a) 1000 ppm relative to the weight of the flour
B: Standard+fermented flour a) 1500 ppm relative to the weight of the flour
C: Standard+fermented flour a) 2000 ppm relative to the weight of the flour
D: Standard+Extract of Sorbus aucuparia L. b) 1000 ppm relative to the total of the recipe
E: Standard+Extract of Sorbus aucuparia L. b) 1000 ppm relative to the total of the recipe
F: Standard+Extract of Sorbus aucuparia L. b) 1500 ppm relative to the total of the recipe
G: Standard+fermented flour a)+Extract of Sorbus aucuparia L. b).

All of the doughs were prepared on the same day so as to be able to work under the same operating conditions and thus avoid influencing the tests in any way. For the preparation of the dough, the first step was to weigh the ingredients foreseen for each sample and place them in a spiral kneader. The kneading step provided for 9 minutes at a first speed followed by 10 minutes at a second speed. Once the kneading step had ended, the dough was left to rest at room temperature for 10 minutes.

Following this rest phase, the dough was split and shaped. The dough was divided and placed in closed loaf pans so as to have portions weighing 550 g each. The leavening step provided for rest in a chamber for 75 minutes at a temperature of 30° C. with a relative humidity of 80%. The doughs thus leavened were baked in an oven at a temperature of 190° C. for a time of 35 minutes. Once the loaves had cooled completely, they were cut so as to have slices of uniform thickness. Every slice was individually packaged and sealed.

An evaluation was then made of the mould visible during the shelf life of the products. All of the bread slices of all samples were stored under the same conditions in order to avoid influencing the test in any way.

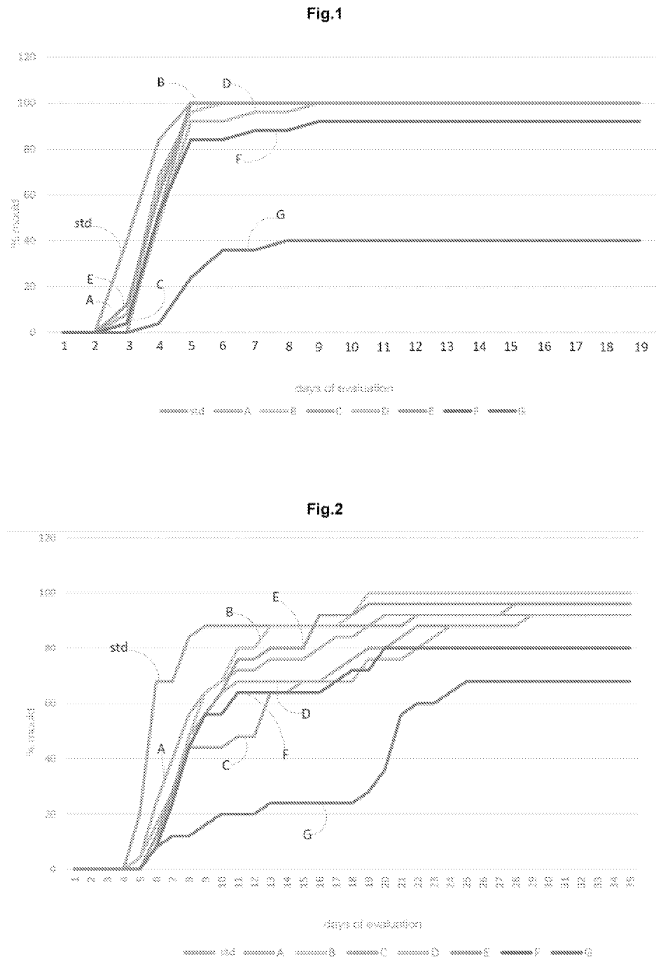

In this case as well, as may be appreciated from the graph shown in FIG. 2, the synergistic effect of the composition according to the present invention in relation to the increase in shelf life compared to the use of fermented flour a) or the extract of Sorbus aucuparia L. b) used individually was demonstrated.

In this case as well, the appearance of mould on sample G (combination of fermented flour a) and extract of Sorbus aucuparia L b)) was not only delayed but also quantitatively lower (below 30% up to day 19 of storage) compared to all of the other samples (standard and samples A-F).

Based on the results that emerged it is thus possible to affirm that the synergistic action of the fermented flour a) and the extract of Sorbus aucuparia L. b) according to the composition of the present invention made it possible to obtain significant improvements in terms of prolonging the shelf life of baked products (in the case of both savoury products like sandwich bread and sweet products) and hence positive results with respect to the longevity and preservation of said products. It is possible to affirm, moreover, that the combination of the two compounds has a synergistically improving effect compared to the two compounds added individually, one that is not ascribable to a mere sum of their individual effects, since, as shown by the graphs, the use of fermented flour or extract added individually (also in different doses) does not enable an improvement in shelf life compared to the standard (i.e. the baked product prepared without additives).

### Example 3—Introduction and Presentation of Tests

The following mixtures were tested:
MIXTURE A: mixture of botanical extract and flour fermented by lactic bacteria.
MIXTURE B: mixture of botanical extract and flour fermented by propionic acid bacteria

### Preparation of the Mixtures

### Mixture A

A composition of flour and lactic bacteria was prepared. The flour was fermented for 18-20 hours at a temperature of about 30° C. After fermentation, the compound was dried until reaching a moisture content of 14%.

### Mixture B

Mixture B was prepared in a similar manner to the first, but using propionic acid bacteria in place of lactic bacteria; the fermented compound was subsequently dried.

The two mixtures, flour fermented by lactic bacteria and flour fermented by propionic acid bacteria, were then suitably mixed with a botanical extract of Sorbus aucuparia L.

### Results

### Improvement in the Shelf Life of a Sandwich Bread

In order to evaluate the synergistic effect given by the natural components present in the mixture, various recipes were tested:
Standard sandwich bread;
Sandwich bread with flour fermented by lactic bacteria and botanical extract in combination;
Sandwich bread with flour fermented by propionic acid bacteria and botanical extract in combination;

The performance of this test was similar to that of the previous tests, and involved a first baking step and a of studying the shelf life, i.e. of second step evaluating the formation of visible mould with different recipes.

As regards the standard recipe, use was made of bread flour, water in an amount of 40 to 80% relative to the weight of the flour, leavening, salt, and micro ingredients.

Starting from the standard recipe, we then added the two mixtures, flour fermented by lactic bacteria and botanical extract and flour fermented by propionic acid bacteria and botanical extract. Specifically, the tests useful for the sandwich bread application were the following:
Standard sandwich bread
A: flour fermented by lactic bacteria and botanical extract in combination.
B: flour fermented by propionic acid bacteria and botanical extract in combination

The tests were coded with letters with the aim of simplifying the study and the collection of useful data. All doughs were prepared on the same day so as to be able to work under the same operating conditions and thus not influence the test in any way. The equipment used for preparation of the bread was: a scale, spiral kneader, leavening chamber, and oven. As regards the preparation of the dough, the first step was to weigh the ingredients foreseen in each recipe. The latter were placed in a spiral kneader in the following order: flour, micro ingredients, leavening, water and, finally, salt. The mixtures of fermented flours and botanical extract were added together to the other ingredients according to the recipe. The kneading step provided for: 3 minutes at a first speed followed by 10 minutes at a second speed.

Once the kneading step had ended, the dough was left to rest at room temperature for 10 minutes. Following this rest phase, the dough was split and shaped. In this study closed loaf pans were used, then the dough was divided so as to have portions weighing 550 g each. The leavening step provided for rested in a chamber for 60 minutes at a temperature of 30° C. with a relative humidity of 80%. The doughs thus leavened were baked in an oven at a temperature of 240° C. for a time of 45 minutes.

Once the loaves had cooled completely, they were cut so as to have slices of uniform thickness. Every slice was individually packaged and sealed. An evaluation was made f the mould visible during the shelf life of the products. All the bread slices were stored under the same conditions in order to avoid influencing the test in any way.

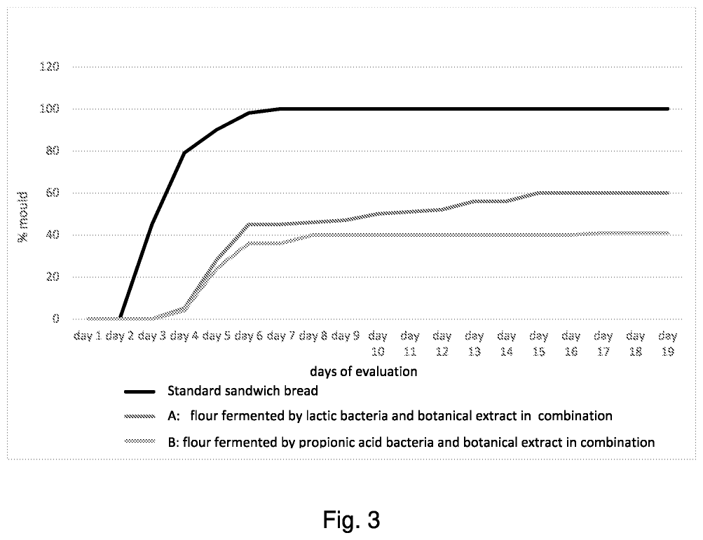

FIG. 3 shows a graph illustrating the appearance of mould over time according to the recipe used.

### Conclusions

Based on the data emerging from these tests, as expected, we can affirm that the synergistic action of the mixtures of fermented flours and botanical extract made it possible to obtain improvements in terms of the life of the baked products. Comparing the two shelf mixtures, the one composed of flour fermented by propionic acid bacteria and botanical extract enables a longer product shelf life to be obtained compared to the mixture with flour fermented by lactic bacteria. As already observed during the first evaluation test, in this case study as well, the addition of the mixture of fermented flour and botanical extract did not result in any changes in terms of appearance and/or colour and/or flavour of the finished product.

### Standard Sandwich Bread

A: flour fermented by lactic bacteria and botanical extract in combination

B: flour fermented by propionic acid bacteria and botanical extract in combination

1. A composition comprising:
a) fermented flour obtained from the fermentation of at least one flour with propionic acid bacteria, said fermented flour comprising at least one organic acid selected in the group consisting of: propionic acid, lactic acid, succinic acid, citric acid, and a combination thereof;
b) an extract of Sorbus aucuparia L., said extract comprising sorbic acid;
c) a carrier selected from the group consisting of: tapioca, maize starch, rice maltodextrins, maize maltodextrins, and a combination thereof.

2. The composition according to claim 1, wherein said at least one flour subjected to fermentation in order to obtain the fermented flour a) is selected from the group consisting of: white flour, semi-wholemeal flour, wholemeal flour or a combination thereof, preferably white wheat flour, semi-whole wheat flour, whole wheat flour, white rice flour, semi-wholegrain rice flour, wholegrain rice flour, or a combination thereof.

3. The composition according to claim 1, wherein said extract of Sorbus aucuparia L. b) is obtained by subjecting berries of Sorbus aucuparia L. to an extraction process with alcohol and/or water at room temperature.

4. The composition of claim 1, wherein said fermented flour a) and said extract of Sorbus aucuparia L. b) are present in a ratio by weight comprised between 20:80 and 80:20.

5. The composition of claim 1, comprising sorbic acid in a total amount comprised between 20 and 40% by weight relative to the total weight of the composition.

6. The composition of claim 1 presented in powder form.

7. A method for preserving food, the method comprising adding to food a composition as defined in claim 1; and
delaying mould appearance on the food.

8. The method of claim 7, wherein said composition is added to the food prior to baking.

9. The method of claim 8, wherein said food is baked.

10. The method of claim 8, wherein said food is selected from the group consisting of jam, cream, and cream and jam.

11. The method of claim 8, wherein said food comprises at least flour and/or water.

12. The method of claim 9, wherein the baked food is selected from the group consisting of bread, biscuits, filled baked products, croissants, leavened breakfast products, cakes, and combinations thereof.

13. The method of claim 10, wherein an amount of visible mould after 19 days of a baked food product was below 30% compared to an amount of visible mould of at least 80% of a baked food product without the composition of claim 1.

14. A food product comprising a composition as defined in claim 1.

15. The food product of claim 14, wherein the food product is baked.

16. The food product of claim 14, wherein the food product is dough.

17. The food product of claim 14, wherein the food product is jam, cream, bread, biscuits, filled baked products, croissants, leavened breakfast products, cakes, or combinations thereof.
